(19) United States
(12) Patent Application Publication
(10) Pub. No.: US 2017/0364958 A1
(43) Pub. Date: Dec. 21, 2017

(54) USING REAL TIME DATA TO AUTOMATICALLY AND DYNAMICALLY ADJUST VALUES OF USERS SELECTED BASED ON SIMILARITY TO A GROUP OF SEED USERS

(71) Applicant: Facebook, Inc., Menlo Park, CA (US)

(72) Inventor: Rituraj Kirti, Los Altos, CA (US)

(21) Appl. No.: 15/184,975

(22) Filed: Jun. 16, 2016

(51) Int. Cl. G06Q 30/02; G06Q 50/00

(52) U.S. Cl. CPC G06Q 30/0269; G06Q 30/0275; G06Q 50/01

(57) ABSTRACT

An online system determines the score for each additional user based on the measure of similarity between the additional user and a group of seed users. The online system divides the additional users into one or more segments according to their respective scores, and assigns a bid amount for each segment. The online system presents sponsored content to the additional users according to the corresponding bid amounts, and for each of the additional users in each segment that is presented with the sponsored content, the online system identifies a value generated by the additional user due to being presented with the sponsored content. The online system uses the identified values of the additional users for each segment to determine an updated configuration of assigned bid amounts for the segments that is predicted to increase a return on investment and assigns the updated bid amounts for each segment.

### BACKGROUND

This disclosure relates generally to online systems storing identity information for users, and in particular to automatic determination of a value for segments of additional users selected based on a similarity to a group of seed users based on data from real-time observation.

Certain online systems, such as social networking systems, allow their users to connect to and to communicate with other online system users. Users may create profiles on such an online system that are tied to their identities and include information about the users, such as interests and demographic information. The users may be individuals or entities such as corporations or charities. Because of the increasing popularity of these types of online systems and the increasing amount of user-specific information maintained by such online systems, an online system provides an ideal forum for entities to increase awareness about products or services by presenting sponsored content to online system users.

Presenting sponsored content to users of an online system allows an entity sponsoring the content to gain public attention for products or services and to persuade online system users to take an action regarding the entity's products, services, opinions, messages, or causes. Generally, these entities each have websites accessible to online system users. However, these entities generally do not have access to the identity information that an online system, such as a social networking system, stores and associates with users, which can be a wealth of valuable targeting information about these users. This limitation of the information available to entities providing sponsored content makes it difficult for them to effectively identify sponsored content to provide to the online system for presentation to various users and to identify which group of users is the optimal to target with this sponsored content.

In other words, the entity is limited in its ability to most efficiently target the sponsored content as the entity has less ability to identify those users of the online system that would respond in a cost effective way to the sponsored content, e.g., those users who would provide a positive return on investment that the entity makes in presenting the sponsored content to the user.

### SUMMARY

Embodiments of the invention include an online system that can automatically determine the value for different segments of users selected based on a similarity of those users to a group of seed users based on data from real-time observation.

In one embodiment, the online system identifies, as seed users, those users of an online system that have a value beyond a certain threshold for a sponsored content provider. This value indicates a benefit provided to the sponsored content provider by the user. In some cases, the benefit may be measured by a return on investment provided by that user. The value may be provided by the sponsored content provider or determined by the online system based on actions performed by the user in the online system.

The online system identifies one or more characteristics of each of the seed users. These characteristics may include the actions performed by the seed users in the online system (e.g., commenting, liking, etc.) and may include the connections made by these users.

The online system then identifies additional users having a measure of similarity to one or more of the seed users that is beyond a threshold measure of similarity. This measure of similarity based at least in part on one or more characteristics of the additional users matching the identified one or more characteristics associated with each of the seed users. For example, the measure of similarity may count a number of similar actions, connections, or other characteristics between two users.

The online system determines a score for each of the additional users, with the score for an additional user based at least in part on the measure of similarity between the additional user and the seed users. For example, the online system may determine as the value score for an additional high value user the measure of similarity for that user normalized against the score for that high value user that the online system had previously computed.

The online system divides the additional users into one or more segments or tiers according to their respective scores. The online system may divide the additional users into the one or more segments according to their respective scores such that the one or more segments include users with ranges of scores in descending order. The online system may also divide the additional users into the one or more segments according to their respective scores such each of the one or more segments include a same number of users as every other segment.

The online system assigns a bid amount for each segment based on an initial configuration. This may include assigning a bid amount to each segment proportional to the range of scores of users within each segment.

For users for which impression opportunities exist, the online system subsequently presents sponsored content to the users according to the corresponding bid amounts. This sponsored content may be provided by the sponsored content provider.

For each of the one or more users in each segment that is presented with the sponsored content, the online system identifies the value generated by the user due to being presented with the sponsored content. To determine this value, the online system may identify, for each user, actions performed by that user in response to being presented with the sponsored content, such as actions that were performed by the user due to the impression opportunities generated based on the bid amounts of the initial configuration. For example, if a user clicks on a sponsored content from the impression opportunity, then that action is performed due to the impression opportunity. The online system determines a weight for each value (e.g., clicking may have a high weight, spending time at the destination indicated by the sponsored content may have a lower weight), and the online system determines, for each user that is presented with the sponsored content, the value based on these weights.

In other cases, to determine the value generated by the user, the online system (randomly) identifies a subset of users of each segment as holdout groups. These holdout group users are excluded from presentation of the sponsored content from the sponsored content provider. The online system identifies the value generated by users in each segment based on the differences in actions performed by users within each segment and users within the corresponding holdout group for that segment. For example, if users in the non-holdout group performed additional clicks on average with the sponsored content provider compared to the users in the holdout group, these clicks might be determined as being caused by the sponsored content being presented to the non-holdout group and be given a value that is assigned to each user.

Using the identified values of users for each segment, the online system determines an updated configuration of assigned bid amounts for the segments that is predicted to increase the value generated by the users in each segment that are presented with the sponsored content (e.g., optimize for return by the user on the investment (ROI) made by the provider). To do this, in some cases the online system performs a multi-arm bandit strategy to analyze the identified values by modifying the bid amount assigned to each segment proportionally based on the change in value of all the users within that segment. The online system may run through multiple iterations of the multi-arm bandit algorithm, along with identifying updated values, to determine an optimal bid value configuration (e.g., this may happen when the value generated by one segment is statistically significant compared to another segment).

The online system may modify the updated bid configuration to reduce any differences between bid amounts of two segments that exceed a threshold amount to reduce bias with subsequent identification of value.

Using such a system, a sponsored content provider may be able to take a hands-off approach to bid determination. The sponsored content provider may only need to provide the online system with a group of high value users, and the online system can automatically determine a bid value that provides an optimal return on investment for the sponsored content provider.

### BRIEF DESCRIPTION OF THE DRAWINGS

FIG. (FIG. 1 is a high level block diagram of a system environment for an online system, according to an embodiment.

FIG. 2 is an example block diagram of an architecture of the online system, according to an embodiment.

FIG. 3 is a flowchart of one embodiment of a method in an online system for automatically determining bid amounts for segments of additional users selected based on a similarity to a group of seed users using real time data, according to an embodiment.

FIG. 4 illustrates a diagrammatic representation 400 of automatic determination of a value for segments of additional users, according to an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

FIG. 1 is a high level block diagram of a system environment 100 for an online system 140, according to an embodiment. The system environment 100 shown by FIG. 1 comprises one or more client devices 110, a network 120, one or more third-party systems 130, and the online system 140. In alternative configurations, different and/or additional components may be included in the system environment 100. In one embodiment, the online system 140 is a social networking system.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

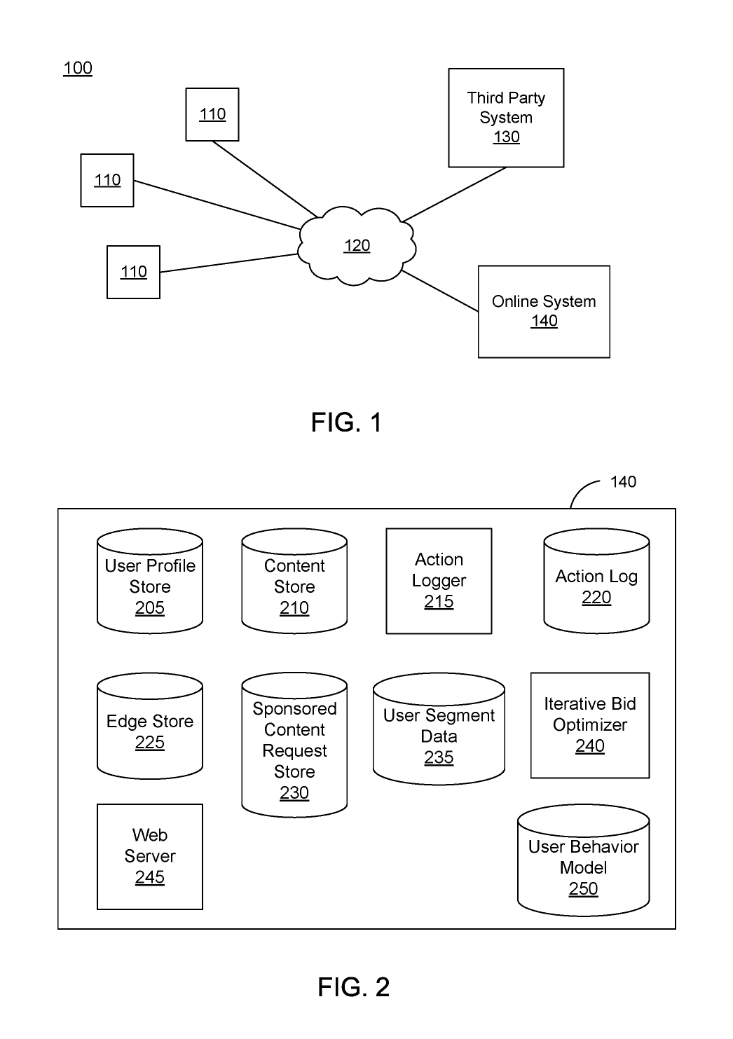

One or more third party systems 130, such as a sponsored content provider system, may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party website 130 may also communicate information to the online system 140, such as advertisements, content, or information about an application provided by the third party website 130. Specifically, in one embodiment, a third party system 130 communicates sponsored content, such as advertisements, to the online system 140 for display to users of the client devices 110. The sponsored content may be created by the entity that owns the third party system 130. Such an entity may be an advertiser or a company producing a product or service that the company wishes to promote.

FIG. 2 is an example block diagram of an architecture of the online system 140, according to an embodiment. The online system 140 shown in FIG. 2 includes a user profile store 205, a content store 210, an action logger 215, an action log 220, an edge store 225, a sponsored content request store 230, a user segment data 235, a iterative bid optimizer 240, a user behavior model 250, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, users of the online system 140 are encouraged to communicate with each other by posting text and content items of various types of media through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions are stored in the action log 210. Examples of interactions with objects include: commenting on posts, sharing links, and checking-in to physical locations via a mobile device, accessing content items, and any other interactions. Additional examples of interactions with objects on the online system 140 that are included in the action log 220 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website that primarily sells sporting equipment at bargain prices may recognize a user of an online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, an edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system, sharing a link with other users of the online system, and commenting on posts made by other users of the online system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's affinity for an object, interest, and other users in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

The sponsored content request store 230 stores one or more sponsored content requests. Sponsored content is content that an entity presents to users of an online system and allows an entity sponsoring the content (i.e., a sponsored content provider) to gain public attention for products, messages, or services and to persuade online system users to take an action regarding the entity's products, services, opinions, or causes. In one embodiment, a sponsored content is an advertisement, and the sponsored content request store 230 stores advertisement requests (“ad requests”). An ad request includes advertisement content, also referred to as an “advertisement” and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented, or if any suitable condition is satisfied when advertisement content in the ad request is presented to a user. For example, the bid amount specifies or is used to compute a monetary amount that the online system 140 receives from the advertiser if advertisement content in an ad request is displayed. In some embodiments, the expected value to the online system 140 of presenting the advertisement content may be determined by multiplying the bid amount by a probability of the advertisement content being accessed by a user.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges, or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sent a message to another user, used an application, joined a group, left a group, joined an event, generated an event description, purchased or reviewed a product or service using an online marketplace, requested information from a third party system 130, installed an application, or performed any other suitable action. Including actions in targeting criteria allows advertisers to further refine users eligible to be presented with advertisement content from an advertisement request. As another example, targeting criteria identifies users having a connection to another user or object or having a particular type of connection to another user or object.

The user behavior model 250 models the behavior of users in the online system 140 and in one embodiment is used to determine a set of users of the online system 140 for which a sponsored content should be targeted towards. The online system 140 feeds either online or offline data to the user behavior model 250 to train it on the behavior of users in the online system 140. In one embodiment, the online system 140 trains the user behavior model 250 using online data. The online system 140 trains the user behavior model 250 by feeding the user behavior model 250 online data regarding actions that users in the online system 140 have performed against sponsored content of a sponsored content provider. The online system 140 also feeds to the user behavior model 250 data regarding a result for the sponsored content provider for each of these users (e.g., as tracked using a tracking pixel). After training the user behavior model 250, the user behavior model 250 may be able to predict for a sponsored content the users and/or groups of users that are most likely to generate a result for a sponsored content provider that gives value to the sponsored content provider when presented with sponsored content. This value may represent any benefit to the sponsored content provider. This benefit may be in the form of purchases, clicks, impressions, or any other action that the sponsored content provider indicates as having a benefit.

In one embodiment, the online system 140 trains the user behavior model 250 by feeding it offline data that include the actions of users against sponsored content and the results of those actions against the sponsored content. Since the data is offline, it may be created manually or may be based on data collected from the online system 140 and then modified.

The structure of the user behavior model 250 may be a decision tree, Bayesian network, neural network, linear regression model, support vector machine, or some other machine learning model.

The iterative bid optimizer 240 determines an optimal bid amount for different segments (i.e., tiers) of users that generates a high overall value for a sponsored content provider. In one embodiment, the iterative bid optimizer 240 selects a set of seed users for a sponsored content provider using the user behavior model 250. Using the user behavior model 250, the iterative bid optimizer 240 determines the users that provide the greatest value to the sponsored content provider. The iterative bid optimizer 240 may determine the type of action that provides the most value to the sponsored content provider and select users that the user behavior model 250 indicates are likely to perform that action.

The iterative bid optimizer 240 may alternatively identify the seed users based on information provided by the sponsored content provider via the third party system 130. In another embodiment, the iterative bid optimizer 240 identifies these users based on other factors, such as the actions of users of the online system 140 with regards to a sponsored content or other similar sponsored content from the sponsored content provider.

In one embodiment, after identifying the set of seed users, the iterative bid optimizer 240 identifies a set of additional users with a measure of similarity to the seed users. This may be performed by comparing the characteristics of the seed users and the additional users and selecting those additional users with a threshold number of shared characteristics. The characteristics for each seed user may include various actions that the seed user has performed with regard to the online system 140, such as those characteristics stored in the user profile store 205, content store 210, action log 220, and edge store 225.

The iterative bid optimizer 240 identifies a score for each of these users (the seed users plus any additional users). The score indicates the value of the user to the sponsored content provider. The score may be determined based on information from the user behavior model 250 indicating how similar the user is to an idealized user of the user behavior model 250, or determined based on a score provided by the sponsored content provider for that user, or based on data collected by the online system 140 regarding the actions of the user (e.g., a return on investment or ROI for the user). In one embodiment, the score for each of the additional users identified by the iterative bid optimizer 240 is based how similar the additional user is to the group of seed users according to the measure of similarity as described above.

The iterative bid optimizer 240 divides these users (the seed users plus any additional users) into multiple segments (or tiers), each segment having users with scores that are within a particular range. Each segment may include a minimum number of users. Subsequently, the iterative bid optimizer 240 assigns a bid amount for each segment with regards to a sponsored content provider. As described above, the bid amount indicates the compensation to be provided to the online system 140 by the sponsored content provider if a sponsored content is presented to a user. In this case, the online system 140, after presenting a user of one of the segments with sponsored content from the sponsored content provider, receives compensation in the bid amount of that segment.

This initial set of bid amounts may not be optimal and may not yield the greatest return for the sponsored content provider, and so the iterative bid optimizer 240 further iteratively modifies the bid amounts based on live data received by the online system 140 regarding the value provided to the sponsored content provider by the users in each segment as a result of presenting the users with sponsored content from the sponsored content provider. As noted above, this value may be defined differently for each sponsored content provider.

In one embodiment, the iterative bid optimizer 240 modifies the bid amounts using a multi-arm bandit method, and increases the bid amounts for those segments for which the data indicates a high amount of value received from presenting users in those segments with sponsored content from the sponsored content provider. This process is iterated by the iterative bid optimizer 240 continuously, or until a statistically significant result is achieved (e.g., the iterative bid optimizer 240 determines that the value received for each segment is statistically significant and may discontinue setting bid amounts for the other segments).

In one embodiment, the iterative bid optimizer 240 may also periodically identify new additional users to be included in each segment according to the process above, and assign bid amounts to these users depending upon the segment they are placed in.

This automatic iteration in the determination of bid amounts allows for the online system to automatically arrive at a proper bid amount for a sponsored content provider in order to automatically optimize the return on investment (ROI) for that sponsored content provider. As new users are added, the iterative bid optimizer 240 may automatically adjust the bid value accordingly. Thus, the sponsored content provider may focus more on generating good sponsored content rather than attempting to determine an optimal bid value, which may be difficult to do by guessing alone.

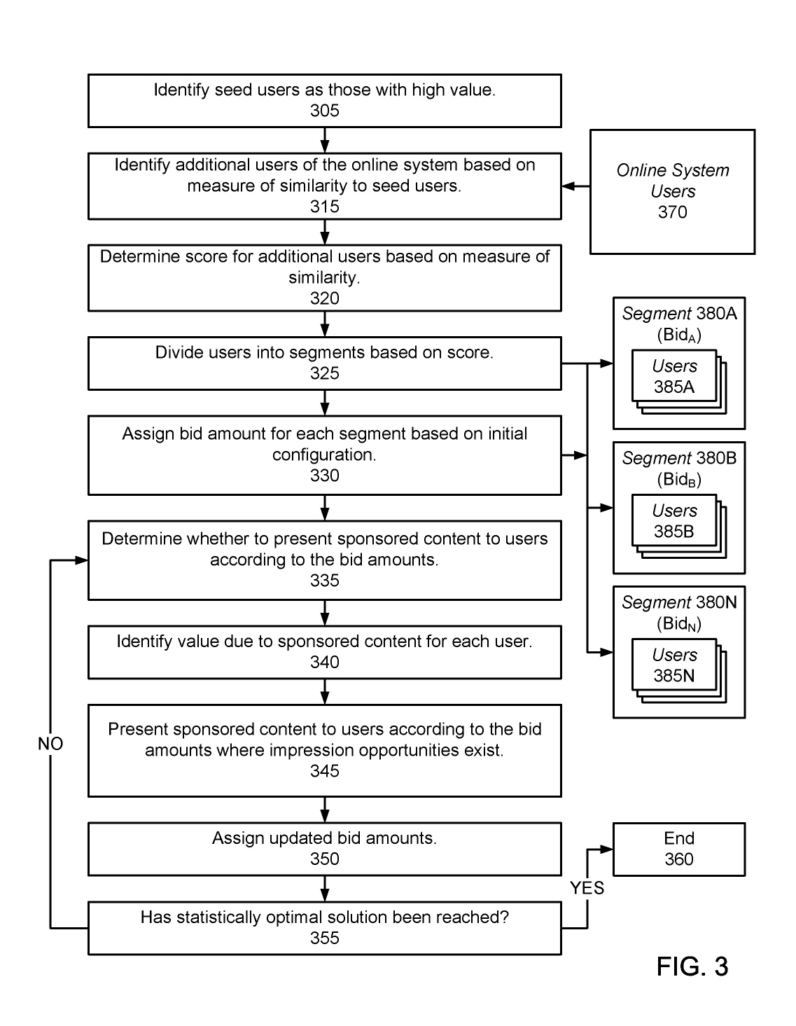

Additional details regarding the iterative bid optimizer 240 will be described with reference to FIG. 3 and FIG . 4.

The user segment data 235 stores the associations between users of the online system 140 and the various segments that those users are identified to be a part of by the iterative bid optimizer 240. Each sponsored content provider may be associated with multiple sets of segments for multiple sponsored content items, and each segment may have a different set of users. The user segment data 235 stores these associations, as well as metadata regarding these associations, such as the value generated by each user as described above as a result of being presented with the sponsored content.

The web server 245 links the online system 140 via the network 120 to the one or more client devices 110, as well as to the one or more third party systems 130. The web server 140 serves web pages, as well as other web-related content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or RIM®.

### Automatically Determining Bid Amounts for Segments of Additional Users Selected Based on a Similarity to a Group of Seed Users Using Real Time Data

FIG. 3 is a flowchart of one embodiment of a method in an online system for automatically determining bid amounts for segments of additional users selected based on a similarity to a group of seed users using real time data, according to an embodiment. In other embodiments, the method may include different and/or additional steps than those described in conjunction with FIG. 3. Additionally, in some embodiments, the method may perform the steps described in conjunction with FIG. 3 in different orders. In one embodiment, the method is performed by the iterative bid optimizer 240.

Initially, the online system 140 identifies 305 seed users of the online system 140 that provide a highest value to the sponsored content provider.

In one embodiment, the online system 140 receives information from the sponsored content provider via the third party system 130 directly identifying a plurality of users as the seed users. This information includes any information that may uniquely identify a user, such as an email address, social network username, unique identifier, contact information, address, phone number, name, and so on. For example, the third party system 130 may provide to the online system 140 a list of email addresses associated with users that the sponsored content provider considers to be of high value. This value may be in regards to a particular sponsored content of the sponsored content provider, or generally for the sponsored content provider.

Once the online system 140 has the list of users, the online system 140 can identify or determine the identity of these users by matching them to user profiles stored in a user profile store of the online system 140 (e.g., user profile store 205), assuming the users on the list from the third party system 130 are also users of the online system and hence have user profiles in the online system, and identifies these matched users as a seed group of users. For example, the online system 140 can match the email address of a user provided by the third party system 130 to an email address in the user profile store to determine that it is the same user, and thus the online system 140 now has additional identifying information about that user (e.g., the information in the user profile). In some cases, not all of users are users of the online system 140, in which case the online system 140 may be unable to identify certain of the users within the online system. These users may be excluded from the seed user group.

In one embodiment, to identify these seed users, the online system 140 receives a business rule from the third party system 130 that identifies users to be placed in audience groups. An audience group is group of one or more users having at least one common characteristic, such as performing a specific type of interaction with content. Examples of interactions include a user visiting a particular page or content, a number of times a user visits a particular page of a website, a user accessing a particular advertisement, a user performing a specified type of action on an application associated with a third party system 130, etc. In one embodiment, an audience group identifier is stored in the user profile store of the online system 140 and is associated with user identifying information of users in the corresponding audience group.

A business rule specifies criteria for generating one or more audience groups including one or more users of the online system 140 and may be provided by the third party system 130. In one embodiment, one or more business rules identify characteristics of users included in an audience group. Examples of business rules include a user in an audience group based on a time elapsed between a current time and a time when a user performed a specific type of interaction, based on types of actions performed by the user with content provided by a third party system 130 (e.g., viewing a page from a website, clicking, interactions with an application, etc.), based on language of content presented to the user (e.g., a French version of website versus an English version of the website), or any other suitable criteria. In some embodiments, a custom audience tool is used to identify the audience groups.

After receiving a business rule identifying seed users, the online system 140 uses the business rule to identify those users with profiles in the online system 140 that satisfy the criteria of the business rule, and identifies these users as being part of an audience group of seed users.

In one embodiment, to identify these seed users, the online system 140 receives identifiers from the third party system 130 that may be used to identify the seed users. The third party system 130 uses a hash function to create a secure identifier hash for each of the users the third party system 130 identifies as seed users. This secure identifier hash does not include personally identifiable information for the user. The third party system 130 then transmits the generated secure identifier hashes to the online system 140. The online system 140 uses an equivalent hashing module to create a locally generated secure identifier hash for users of the online system 140. If the locally generated secure identifier hash matches any of the secure identifier hashes received from the third party system 130, the user of the online system 140 that is identified by the locally generated hash is identified as a seed user.

Methods of identifying users by a third party system are further described in U.S. patent application Ser. No. 13/306,901, filed on Nov. 29, 2011, U.S. patent application Ser. No. 14/034,350, filed on Sept. 23, 2013, U.S. patent application Ser. No. 14/177,300, filed on Feb. 11, 2014, and U.S. patent application Ser. No. 14/498,894, filed on Sept. 26, 2014, all of which are hereby incorporated by reference in their entirety.

In one embodiment, the online system 140 itself identifies seed users (or users expected to be of high value to the third party) without input by the third party system 130. The online system 140 can do this by, for example, determining if the actions performed by users after being presented with the sponsored content from the third party system 130 exceed a specified metric.

The actions performed by the users are logged by the online system 140 as described above, and can include actions such as liking, sharing, and otherwise engaging with the sponsored content or objects in the online system 140 that are related to the sponsored content. In one embodiment, the objects that are related to the sponsored content are within a certain degree of connections to the sponsored content. The connections may be stored as edges of the online system 140 as described above.

The actions may also include actions performed outside the online system 140 regarding the sponsored content, such as installing an application on a client device that was promoted by the sponsored content, visiting a web page or other location promoted by the sponsored content, and so on. This information may be provided by the third party system 130 or tracked by the online system 140 using a tracking identifier placed on the user's client device.

The online system 140 determines if the actions performed exceed a certain metric. The metric may be a threshold count of actions, a threshold number of actions made against the sponsored content, a threshold number of actions performed outside the online system 140, and/or any other relevant metric that may be used to measure the value of the user in response to being presented by the sponsored content.

The metric may be an amount of profit (e.g., ROI) generated by the user' actions for the third party system 130 as a result of being presented with the sponsored content. In one embodiment, the ROI for users is calculated by the third party system 130 and provided to the online system. The online system 140 identifies the users of the online system that match the users provided by the third party system 130 (e.g., by matching characteristics of the user's profile with the information provided by the third party system 130), and selects those users that exceed a certain ROI value (e.g., top 1% of ROI among the ROI values provided) as the seed users.

In one embodiment, the third party system 130 provides the online system 140 with estimated revenue for certain types of actions related to the sponsored content, and the online system 140 calculates the estimated revenue for each user based on the actions performed by that user. Those users that exceed a certain estimated revenue are then selected by the online system 140 as seed users.

In one embodiment, the online system 140 selects the seed users based on a model of user behavior. As described above, the user behavior model may model user behavior based on online or offline training data. After being trained with the training data, the user behavior model attempts to identify a set of users of the online system 140 that may most frequently perform a particular action or set of actions which provide a benefit to a sponsored content provider.

In one embodiment, the online system 140 removes those from the group of seed users those users that have shown a period of inactivity within the online system 140 or a period of inactivity with regards to the sponsored content provider.

In some embodiments, for each seed user that is identified, the online system 140 also identifies a score for that seed user that represents a value of that user to the sponsored content provider. As noted above, the value of a user to the sponsored content provider is any benefit that the user provides to the sponsored content provider. This benefit may represent clicks per impression for the user, return on investment (ROI) for the user, conversion rate for the user (per impressions), revenue generated for the user, time spent at a location of the sponsored content provider, and so on. The benefit may be defined by the sponsored content provider, and received from the third party system 130, or may be determined by the online system 140 based on some default configuration (e.g., clicks per impression may be used as the default benefit measured for each user).

The score for each seed user may be provided by the sponsored content provider via the third party system 130 or determined by the online system 140. In one embodiment, the score is provided by the third party system 130. This score may directly represent some real statistic measured by the sponsored content provider, such as the revenue generated by each user, or it may represented an abstracted score that the third party system 130 generated based on that statistic, as the sponsored content provider may wish to keep some information confidential. For example, the third party system 130 may provide the score as a normalized version of one of the real statistic values.

In another embodiment, the online system 140 determines a score for one or more of the seed users, or as a second score for one or more of the seed users to supplement the score provided by the third party system 130. To determine a score for each identified seed user in the online system 140, the online system 140 may give a weighted value to each action performed by that seed user in the online system 140 in connection with the sponsored content provider. These may be any actions that the online system 140 may track and which are connected with a particular sponsored content, campaign, group of sponsored content, or other element of the sponsored content provider that the online system 140. For example, an action may include a user clicking on a sponsored content of the sponsored content provider, or may include a user liking a page owned by the sponsored content provider. The weighted value of each action for the seed user may be combined into a score for that seed user (e.g., by adding the weighted values into a normalized score). In other embodiments, the online system 140 determines the score using a different method.

Once the group of seed users is selected, the online system identifies 315 additional users from the users 370 of the online system 140 that have at least a threshold measure of similarity to one or more of the seed users.

In one embodiment, the online system identifies those additional users as users having at least a threshold number or percentage of characteristics matching or similar to characteristics of the seed users. In some embodiments, the online system 140 identifies additional users having at least a threshold number or percentage of interests matching interests specified by at least a threshold number of the seed users. These interests may be stored in user profiles of the users. Similarly, the online system 140 may identify additional users who interacted with content items of the online system 140 having at least a threshold number or percentage of characteristics matching characteristics of content items with which the seed users interacted. Other characteristics can also be utilized, such as matching demographics between users, similar affinity scores for particular content or types of content, connections to similar content or users, similar patterns of interacting with content, etc.

The online system 140 may train and apply a model to the characteristics of the seed users and the content items that the seed users have interacted with. The model may be any type of statistical model that can make a prediction (e.g., in the form of a percentage) of a similarity of characteristics of a user of the online system 140 to the characteristics trained in the model. For example, a model may predict the similarity based on how many characteristics are shared between two users out of a total number of characteristics logged by the online system 140. Using the model, the online system 140 identifies additional users that have a threshold measure of similarity to the seed users.

The actual threshold value for the threshold measure of similarity may be set at a particular number of sigmas of a standard deviation of all (or a random sampling of) users of the online system 140 as measured using the measurement for the threshold measure of similarity. Alternatively, the threshold measure may be set to the average value of all (or a random sampling of) users of the online system 140 as measured using the measurement for the threshold measure of similarity.

Additional methods of determining similarity between groups of users of an online system are further described in U.S. patent application Ser. No. 13/297,117, filed on Nov. 15, 2011, U.S. patent application Ser. No. 14/290,355, filed on May 29, 2014, U.S. patent application Ser. No. 14/719,780, filed on May 22, 2015, all of which are hereby incorporated by reference in their entirety.

In one embodiment, the seed users and additional users that are identified by the online system 140 are limited to a particular geographical area. The geographical location of each user may be determined by the online system 140 using information in the user's user profile or using other methods such as IP geolocation.

Once the online system 140 identifies the seed users and the additional users, the online system further determines 320 a score for each of the additional users in the based at least in part on a measure of similarity between the additional users and the seed users. In one embodiment, the score is a scaled value, with those users nearest the threshold measure of similarity receiving a lowest score in the scale, and those users with a measure of similarity closest to the seed users receiving the highest score in the scale. In one embodiment, the score is a percentage scale from 0% to 100%, with users closest to the seed users receiving a percentage value of 100% (or 99%, with the seed users receiving a score of 100%), and those users at the threshold measure of similarity receiving a score of 1% or 0%. In one embodiment, the online system 140 determines the scores of the additional users using the methods described above for determining the score for the seed users.

Subsequently, the online system 140 divides 325 the additional users into one or more segments based on the scores of the additional users. The online system 140 may also divide the seed users into one or more segments according to the score determined for the seed users.

In one embodiment, the online system 140 divides the previously identified users 385 into segments 380 that each include an equal number of users. These users 385 may include the seed users, the additional users, or both. If only the seed users are divided into the segments 380, then the online system 140 may forgo the identification of the additional users.

Furthermore, each segment 380 includes users that have a score that are within a certain range. As described previously, the scores for the seed users may be determined in a variety of ways, and the scores for the additional users may be additionally determined based on a measure of similarity to the seed users.

The number of users within each segment may be set to at least a minimum amount. This minimum amount is to ensure that subsequent statistical analysis of each segment can derive a statistically significant result.

In one embodiment, the ranges of scores associated with each segment do not overlap, such that all the segments represent the total range of scores of the users that are to be divided. The number of users per segment may be determined by the online system 140 as a percentage of a number of users within a geographic region of the seed users (e.g., each segment represents 1%).

In another embodiment, the ranges of scores for each segment do overlap, and the number of users in each segment may differ. To determine how many users may be placed in each segment in this case, the online system 140 may use the user behavior model to identify those users that have the most similar characteristics within a percentage variation. In particular, these characteristics may include actions and the number of actions that the user behavior model predicts that these users will perform. The users that are predicted to perform similar actions or a similar number of actions may be grouped by the online system 140 into the same segments.

The online system 140 also assigns 330 a bid amount for each segment based on an initial configuration. The bid amount of each is the amount of compensation provided to the online system 140 by the sponsored content provider for showing an associated sponsored content or one of a set of sponsored content items to a user within that segment. In one case, this initial configuration may be to assign equal bid amounts to each of the segments. This bid amount should be set high enough such that users within that segment are presented with sponsored content from the sponsored content provider (i.e., the bid for the sponsored content is not always outbid).

In other embodiments, each segment initially receives a differing bid amount that is proportional to the range of scores of users 385 within that segment. For example, segments that have higher scores may receive higher bid amounts, while those with lower scores may receive lower bid amounts.

In all cases, the bid amounts may further be constrained by the sponsored content provider such that the bid amounts fall within a budget of what the sponsored content provider is willing to pay for each bid.

After setting these initial bid amounts, the online system 140 makes the configuration live (i.e., active within the online system 140). During this time, the online system 140 gathers data about effect of the bid amounts. One or more users 385 in each segment 380 may have the opportunity to be presented with an impression for a sponsored content. If the online system 140 determines that an impression opportunity exists for a user 385 in one of the segments 380, the online system may present the associated sponsored content if constraints are met. In particular, the bid amount must be sufficient such that the bid for that impression opportunity is won, and in some cases, the targeting criteria for the associated sponsored content must also be met. If all constraints are met, the online system presents 335 the selected sponsored content to the user in the segment. In general, this process may proceed in a similar fashion to the normal presentation of sponsored content to users of the online system 140.

Periodically, the online system 140 identifies 340 the value generated by each of the users 385 in the one or more segments 380 due to that user 385 being presented with the sponsored content. As noted above, this value is a benefit that is provided to the sponsored content provider. To determine whether the value of the user has increased or that value has been generated by the user, the online system 140 may once again calculate the a score of the user according to one of the methods described above, and compare that score to a previous score computed for the user. A difference in the scores may indicate an added value generated by that user for the sponsored content provider due to being presented with the sponsored content.

In addition, the online system 140 may place one or more users 385 in each segment 380 in a hold out group, such that these users are never presented with the sponsored content, but instead presented with other sponsored content from other sponsored content providers. This allows the online system 140 to develop a control set of users and perform a lift analysis in order to determine the added value generated by the users 385 in response to being presented with the sponsored content. The online system 140 may identify 340 these values according to any period, such as every hour, every day, and so on.

The period may be shorter or greater depending upon how much data is being collected by the online system 140. For example, if sponsored content from the sponsored content provider is frequently being presented to one or more users in the segments, then the period may be shorter.

After identifying the value generated by the users, the online system 140 determines 345 an updated configuration of bid amounts for each segment using the values that have been identified 340 from the real-time data.

In one embodiment, the online system 140 uses a multi-arm bandit strategy to analyze the identified values in order to modify the bid amounts for each segment. In one embodiment, those segments that have users with a large number of users with increased value may have their bid amounts increased by an amount proportional to the number of users with increased value. In another embodiment, those segments with users that have large increases in value may have their bid amounts increased proportionally according to some statistical measure (e.g., a geometric mean, normalization) of the value of the users in that segment. In one embodiment, the online system 140 increases the value of each segment based on a combination of these methods.

In one embodiment, the online system 140 decreases the bid amount in a segment that is proportional to an underperformance in the value of the users in that segment (e.g., in accordance with a statistical measure). This underperformance may be indicated by a lesser number of users who had increased in value in the segment compared to other segments, a decrease in value for users in the segment, a lesser amount of increase of value for users in the segment compared to other segments, and so on. For example, one segment may have had 100 users that had their value increased, while another may have only had 5 users. In such a case, the online system 140 may reduce the bid amount for the segment with 5 users changed, and may also increase the bid amount for the segment with 100 users changed.

Although the online system 140 modifies the bid amount of each segment, in one embodiment no segment has a bid amount set to zero. This is because during the multi-arm bandit analysis, if a bid amount of a segment is reduced to zero, no data can later be acquired for that segment, as no bids are ever made for that segment. Furthermore, as user profiles and other aspects of the online system 140 change, and as the multi-arm bandit process iterates to reach statistical significance, these segments that are underperforming may later perform better. Thus, the bid amount is not set to zero.

For example, if the online system 140 has only two segments for a particular sponsored content, the segment that is performing well (i.e., with good identified value) may be exploited to receive a bid amount that is 90% of a maximum bid amount specified, and the other segment may be explored to receive 10% of the maximum bid amount specified. Note that the particular bid amounts and how much they may change may be modified by the online system 140 for each sponsored content according to a configuration by the sponsored content provider.

In one embodiment, the amount of change in the bid amounts is also modified to avoid creation of a statistical bias. For example, if a bid amount is set very high for a particular segment, a subsequent analysis of the value provided by the users of that segment compared to other segments may be unfairly biased, as the difference in value generated between the segments may have been influenced by the large difference in bid amount and not just the characteristics of the users in each segment and the observed tendency of the users in each segment to generate value for the sponsored content provider. Thus, the online system 140 may also weight or discount the changes in value based upon the differences in bid amounts between segments to account for this potential bias.

In other embodiments, the online system 140 uses a different method of modifying bid amounts, such as via A/B testing.

Once a new set of bid amounts is determined 345 based on the identified values, the online system 140 assigns 350 these updated bid amounts in an updated configuration to the segments. The new bid amounts are used in the live system again, and the online system 140 repeats the process of identifying 340 values, determining 345 new bid amounts, and assigning 350 updated bid amounts for multiple iterations. This allows the bid amounts to be continuously refined such that the segments with users that are most likely to generate value for the sponsored content provider are given the highest bid amounts. As the users in these high value segments are observed to generate the most value for the sponsored content provider in response to being presented with sponsored content from the sponsored content provider, a sponsored content provider will naturally wish to have more opportunities to present sponsored content to the users of these segments by bidding with a higher bid amount for these users, beating out other sponsored content providers in the process.

In one embodiment, the online system 140 may determine 355 that an optimal solution has been reached. The online system 140 may determine that an optimal solution is reached when the increase in value due to changes in bid configuration is below a threshold value. Alternatively, the online system 140 may determine that an optimal solution is reached when that solution displays a statistical significance over the prior bid configurations. If an optimal solution is reached, then the process ends 360, at least temporarily. After a longer period of delay, or after detection of significant changes in the online system 140 (e.g., new users added, changes to the sponsored content or the sponsored content provider), the online system may once again perform one or more of the operations in FIG. 3, such as identifying 305 seed users, in order to update the bid amounts.

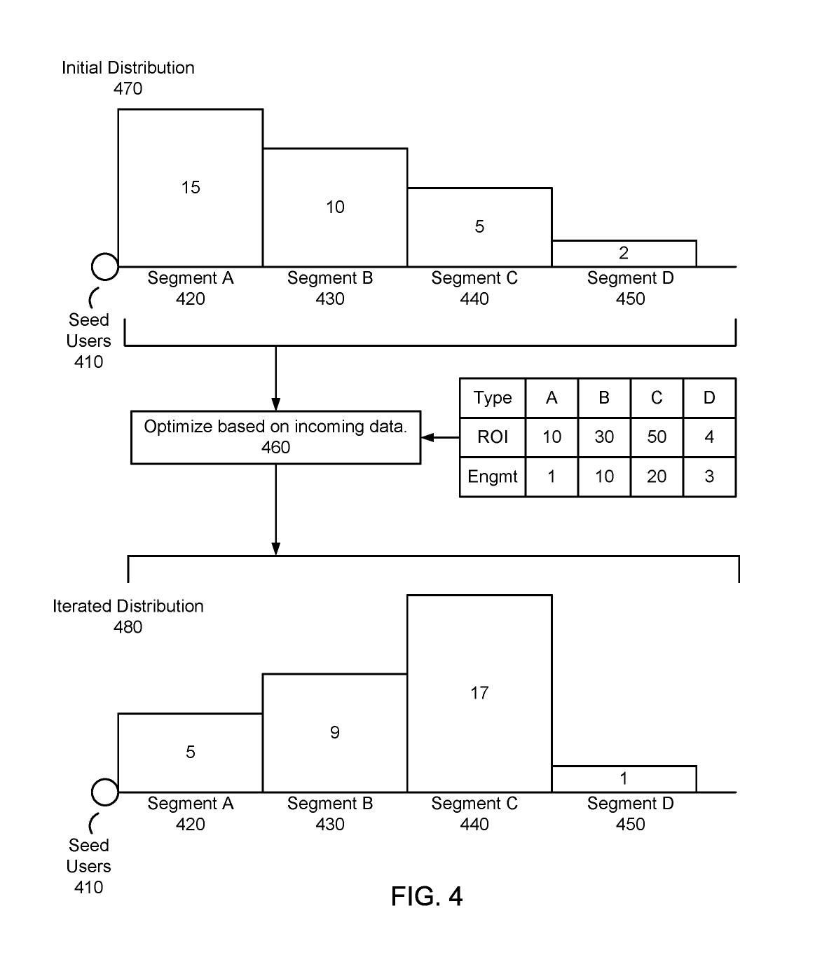

FIG. 4 illustrates a diagrammatic representation 400 of automatic determination of a value for segments of additional users, according to an embodiment.

In an exemplary initial distribution 470, the online system 140 assigns bid values to users in each segment, with each segment having users with a measure of similarity to the seed users 410. In the exemplary initial distribution 470, segment A 420 is assigned a bid value of 15, segment B 430 is assigned a bid value of 10, segment C a bid value of 5, and segment D 450 a bid value of 2. These bid values may be assigned based on the computed value of the users in each segment. The visual height of each segment in the representation 400 indicates the bid value of that segment and not the number of users in that segment.

After employing the assigned bid values in the initial distribution 470, the online system 140 receives data regarding the performance of these bid values as described above. As shown in the representation 400, this performance may be indicated as ROI, or alternatively as engagement, and so on.

Based on the performance data, the online system 140 optimizes 460 the bid values based on the incoming data, according to the methods described above (e.g., by using multi-armed bandit). This results in an iterated distribution 480, where the segments that had higher performance indicators are now assigned higher bid amounts. In the exemplary distribution 480, the ROI of users in segment C 440 was indicated to be 50, and was higher than the other segments. Consequently, the online system 140 assigns a higher bid value to the segment C 440 of 17, and may lower the bid values of the other segments correspondingly. Although the ROI of users in segment D 450 is low, the online system 140 does not set a bid value of zero for segment D 450, but instead sets it to a non-zero bid value.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
identifying, as seed users, those users of an online system that have a value beyond a certain threshold to a sponsored content provider, the value indicating a benefit provided to the sponsored content provider by a user;
identifying one or more characteristics of each of the seed users;
identifying additional users having a measure of similarity to one or more of the seed users that is beyond a threshold measure of similarity, the measure of similarity based at least in part on one or more characteristics of the additional users matching the identified one or more characteristics associated with each of the seed users;
determining a score for each of the additional users, the score for an additional user based at least in part on the measure of similarity between the additional user and the seed users;
dividing the additional users into one or more segments according to their respective scores;
assigning a bid amount for each segment based on an initial configuration;
presenting sponsored content to a plurality of the additional users according to the corresponding bid amounts;
for each of the additional users in each segment that is presented with the sponsored content, identifying a value generated by the additional user due to being presented with the sponsored content;
using the identified values of the additional users for each segment, determining an updated configuration of assigned bid amounts for the segments that is predicted to increase a return on investment generated by the additional users in each segment that are presented with the sponsored content; and
assigning the updated bid amounts based on the updated configuration for each segment.

2. The method of claim 1, wherein the dividing the additional users into one or more segments further comprises:
dividing the additional users into the one or more segments according to their respective scores such that the one or more segments include users with ranges of scores in descending order.

3. The method of claim 1, wherein the dividing the additional users into one or more segments further comprises:
dividing the additional users into the one or more segments according to their respective scores such each of the one or more segments includes a same number of users as every other segment.

4. The method of claim 1, wherein assigning a bid amount for each segment based on an initial configuration further comprises:
assigning a bid amount to each segment proportional to the range of scores of users within each segment.

5. The method of claim 1, wherein the identifying the value generated by the user due to being presented with the sponsored content further comprises:
identifying, for each user, actions performed by that user in response to being presented with the sponsored content, the actions due to the impression opportunities generated based on the bid amounts of the initial configuration; and
determining, for each user, the value generated by the user based on a weighted computation of the identified actions.

6. The method of claim 1, wherein the identifying the value generated by the user due to being presented with the sponsored content further comprises:
identifying a subset of users of each segment as holdout groups, the users of each holdout group excluded from presentation of the sponsored content;
identifying the value generated by users in each segment based on the differences in actions performed by users within each segment and users within the corresponding holdout group for that segment.

7. The method of claim 1, wherein the determining an updated configuration of assigned bid amounts for the segments further comprises:
performing a multi-arm bandit strategy to analyze the identified values by:
modifying the bid amount assigned to each segment proportionally based on the change in value of all the users within that segment.

8. The method of claim 1, wherein the updated configuration of bid amounts is modified to reduce any differences between bid amounts of two segments that exceed a threshold amount to reduce bias with subsequent identification of value.

9. The method of claim 1, wherein the steps of identifying the value generated by the user, the determining an updated configuration and assigning the updated bid amounts are periodically repeated for one or more iterations.

10. The method of claim 9, wherein the repetition continues until an optimal solution is reached such that the increase in total value does not exceed a threshold value after an iteration.

11. A computer program product comprising a non-transitory computer readable storage medium having instructions encoded thereon that, when executed by a processor, cause the processor to:
identify, as seed users, those users of an online system that have a value beyond a certain threshold to a sponsored content provider, the value indicating a benefit provided to the sponsored content provider by a user;
identify one or more characteristics of each of the seed users;
identify additional users having a measure of similarity to one or more of the seed users that is beyond a threshold measure of similarity, the measure of similarity based at least in part on one or more characteristics of the additional users matching the identified one or more characteristics associated with each of the seed users;
determine a score for each of the additional users, the score for an additional user based at least in part on the measure of similarity between the additional user and the seed users;
divide the additional users into one or more segments according to their respective scores;
assign a bid amount for each segment based on an initial configuration;
present sponsored content to a plurality of the additional users according to the corresponding bid amounts;
for each of the additional users in each segment that is presented with the sponsored content, identify a value generated by the additional user due to being presented with the sponsored content;
use the identified values of the additional users for each segment to determine an updated configuration of assigned bid amounts for the segments that is predicted to increase a return on investment generated by the additional users in each segment that are presented with the sponsored content; and
assign the updated bid amounts based on the updated configuration for each segment.

12. The computer program product of claim 11, the non-transitory computer readable storage medium having further instructions encoded thereon that, when executed by a processor, cause the processor to:
divide the additional users into the one or more segments according to their respective scores such that the one or more segments include users with ranges of scores in descending order.

13. The computer program product of claim 11, the non-transitory computer readable storage medium having further instructions encoded thereon that, when executed by a processor, cause the processor to:
divide the additional users into the one or more segments according to their respective scores such each of the one or more segments includes a same number of users as every other segment.

14. The computer program product of claim 11, the non-transitory computer readable storage medium having further instructions encoded thereon that, when executed by a processor, cause the processor to:
assign a bid amount to each segment proportional to the range of scores of users within each segment.

15. The computer program product of claim 11, the non-transitory computer readable storage medium having further instructions encoded thereon that, when executed by a processor, cause the processor to:
identify, for each user, actions performed by that user in response to being presented with the sponsored content, the actions due to the impression opportunities generated based on the bid amounts of the initial configuration; and
determine, for each user, the value generated by the user based on a weighted computation of the identified actions.

16. The computer program product of claim 11, the non-transitory computer readable storage medium having further instructions encoded thereon that, when executed by a processor, cause the processor to:
identify a subset of users of each segment as holdout groups, the users of each holdout group excluded from presentation of the sponsored content;
identify the value generated by users in each segment based on the differences in actions performed by users within each segment and users within the corresponding holdout group for that segment.

17. The computer program product of claim 11, the non-transitory computer readable storage medium having further instructions encoded thereon that, when executed by a processor, cause the processor to:
perform a multi-arm bandit strategy to analyze the identified values by:
modify the bid amount assigned to each segment proportionally based on the change in value of all the users within that segment.

18. The computer program product of claim 11, wherein the updated configuration of bid amounts is modified to reduce any differences between bid amounts of two segments that exceed a threshold amount to reduce bias with subsequent identification of value.

19. The computer program product of claim 11, wherein the operations of identifying the value generated by the user, the determining an updated configuration and assigning the updated bid amounts are periodically executed by the processor for one or more iterations.

20. The computer program product of claim 19, wherein the execution continues until an optimal solution is reached such that the increase in total value does not exceed a threshold value after an iteration.
